(19) United States
(12) Patent Application Publication
(10) Pub. No.: US 2007/0037019 A1
(43) Pub. Date: Feb. 15, 2007

(54) Purified polyurethane crosslinking agents and magnetic recording media having at least one coating containing a purified polyisocyanate crosslinking agent

(75) Inventors: Stanley C. Busman, North St. Paul, MN (US); Matthew N. Fraley, Minneapolis, MN (US); James A. Greczyna, Vadnais Heights, MN (US); Meng C. Hsieh, Woodbury, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/200,580

(22) Filed: Aug. 9, 2005

(51) Int. Cl. G11B 5/706; G11B 5/716

(52) U.S. Cl. 428/840.5; 428/844.6; 428/844.8; 428/845.7

(57) ABSTRACT

A purified polyurethane crosslinking agent and a magnetic recording medium comprising a substrate having coated thereon a front coat and a backcoat, said front coat comprising at least a magnetic coating and at least one of said front coat or said backcoat containing at least polymeric binder with pendant hydroxyl groups and a purified polyisocyanate crosslinking agent therefor comprising at least one diisocyanate compound adduct selected from the group consisting of adducts having a formula 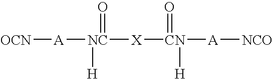 wherein: each A moiety is independently a divalent, organic linking group; and X is a divalent organic linking group, and
a diisocyanate compound adduct of the formula 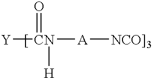 wherein each A moiety is as defined above, and Y is a trivalent organic linking group.

### THE FIELD OF THE INVENTION

The present invention relates generally to a purified polyurethane crosslinking agent and to a magnetic recording medium having at least one coating containing significantly reduced amounts of methylene bis(4-phenylisocyanate). Specifically, the invention relates to a magnetic recording medium having at least one coating containing a purified polyisocyanate crosslinking agent.

### BACKGROUND OF THE INVENTION

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders, and the like, dispersed in binders and coated on a substrate. In general terms, such magnetic recording media generally comprise a magnetic layer coated onto at least one side of a non-magnetic substrate (e.g., a film for magnetic recording tape applications). The formulation for the magnetic coating is optimized to maximize the performance of the magnetic recording medium.

Magnetic recording media also typically have a backside coating applied to the opposing side of the non-magnetic substrate in order to improve the durability, conductivity, and tracking characteristics of the media.

Particulate based magnetic recording media include a granular pigment. Popular pigments are metal oxides, ferromagnetic metal oxides, and ferromagnetic metal alloys. Different pigments have different surface properties; the metal particles often have a strongly basic surface. Recording media often utilize ferromagnetic particles in the formulations such as gamma iron oxide (γ-Fe₂O₃), magnetite (Fe₃O₄), cobalt-doped iron oxides, or ferromagnetic metal or metal alloy powders, along with carbon black particles.

Magnetic recording layers typically include a polymeric binder or resin composition containing pendant hydroxyl groups. The binder composition performs such functions as dispersing the particulate materials, increasing adhesion between layers and to the substrate, improving gloss and the like. As might be expected, the formulation specifics as well as coating of the binder compositions to an appropriate substrate are highly complex, and vary from manufacturer to manufacturer; however, most binders include such materials as thermoplastic materials.

When polymeric binder materials containing pendant hydroxyl groups are used in one or more layers, they are typically crosslinked by means of polyisocyanate crosslinking agents in the formation of the respective coating. Crosslinking agents, however, may introduce contaminants into the system such as free diisocyanate compounds, which can affect the properties of the coatings, or the crosslinking agents themselves may be compounds which negatively affect the ability of the formulation to form a good film coating.

It would be desirable to have a magnetic recording medium wherein the polyisocyanate crosslinking agent used is both film-forming and low in free diisocyanates such as methylene bis(4-phenylisocyanate).

### SUMMARY OF THE INVENTION

The invention provides a purified polyurethane crosslinking agent comprising at least one diisocyanate compound adduct selected from the group consisting of adducts having a formula 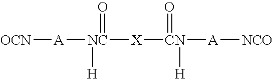
wherein:

each A moiety is independently a divalent, organic linking group; and

X is a divalent organic linking group, and

a diisocyanate compound adduct of the formula 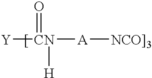
wherein:

each A moiety is as defined above; and

Y is a trivalent organic linking group, and the purified polyurethane crosslinking agent contains less than 2% free diisocyanate compound.

In one embodiment of the purified polyurethane crosslinking agent, moiety A is selected from 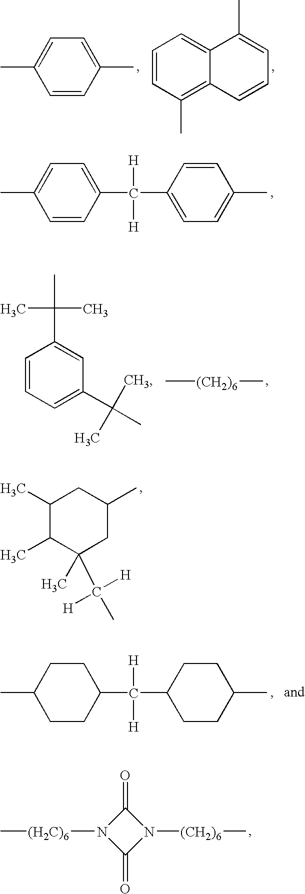
moiety X has the formula
—OR¹O—,
wherein R¹ is a divalent, organic linking group selected from 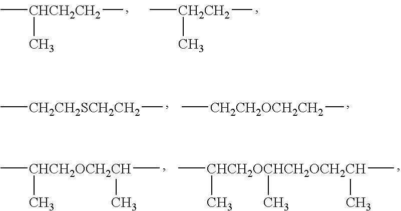
and moiety Y has the formula 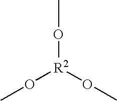
wherein R² is a trivalent, organic linking group selected from

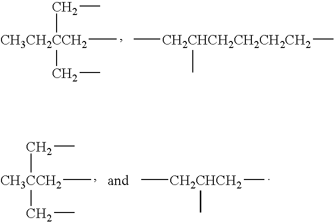

The invention further provides a magnetic recording medium comprising a substrate having coated thereon a front coat and a backcoat, said front coat comprising at least a magnetic coating and at least one of said front coat or said backcoat containing at least a polymeric binder with pendant hydroxyl groups and a purified polyisocyanate crosslinking agent therefore comprising at least one diisocyanate compound adduct having a formula selected from the group consisting of 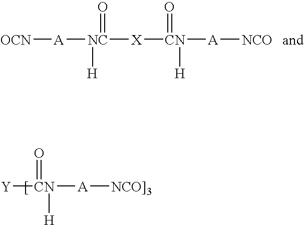
wherein:

each A moiety is independently a divalent, organic linking group;

X is a divalent organic linking group, and Y is a trivalent organic linking group, and the amount of free isocyanate compound represented by the formula OCN-A-NCO is less than 2%.

In one embodiment of the magnetic recording medium, the moiety A is selected from the group consisting of

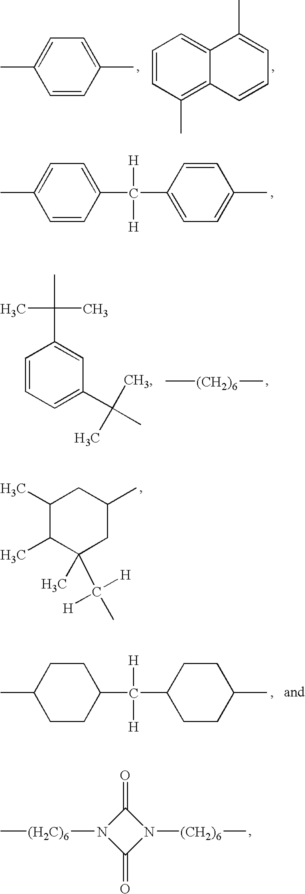

In another embodiment, the moiety X has the formula
—OR¹O—,
wherein R¹ is a divalent, organic linking group and the moiety Y has the formula 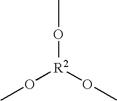
wherein R² is a trivalent, organic linking group.

In another embodiment of the magnetic recording medium, R¹ in the X moiety is selected from the group consisting of

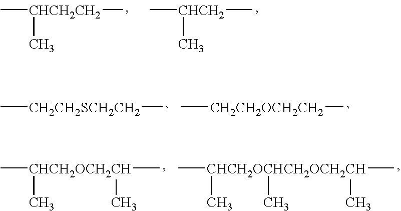

In another embodiment, R² in the Y moiety is selected from the group consisting of

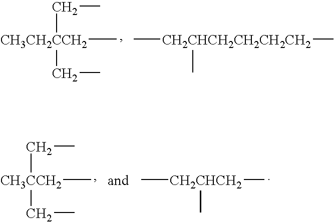

In another embodiment of the magnetic recording medium, each A moiety is an independently selected divalent, organic linking group having a chemical structure such that each NCO group pendant from each A moiety is aromatic and unhindered.

In yet another embodiment, the invention provides a magnetic recording medium comprising a substrate having coated thereon a front coat and a backcoat, wherein the front coat comprises at least a magnetic coating and at least one of the coatings contains at least one polymeric binder with pendant hydroxyl groups and a purified polyisocyanate crosslinking agent comprising at least one diisocyanate compound adduct having the formula DPG, a second diisocyanate compound adduct having the formula TPG, and a third diisocyanate compound adduct having the formula TMP. 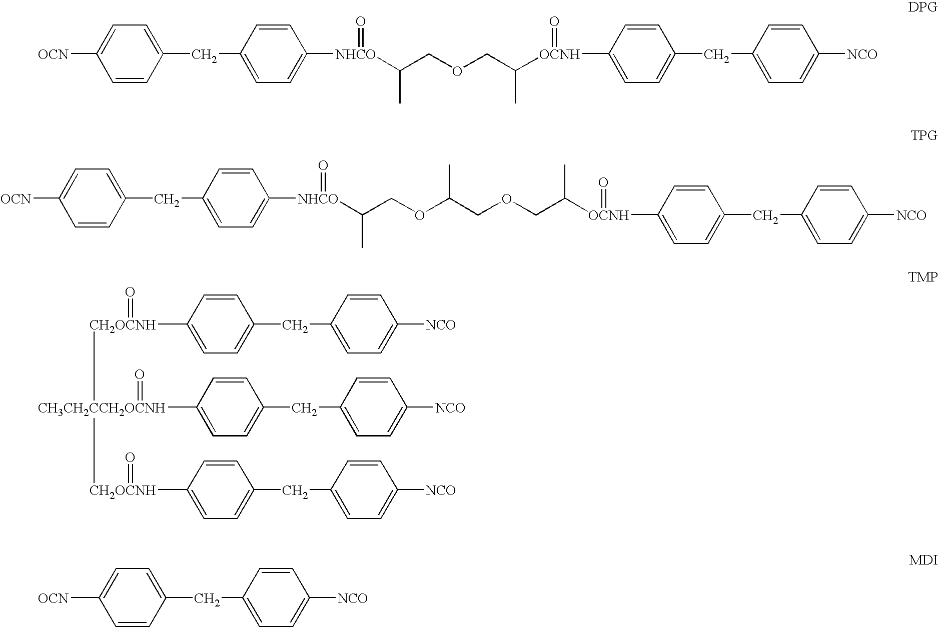
wherein such coating contains less than about 2% free methylene bis(4-phenylisocyanate) (MDI).

In one magnetic recording medium embodiment, the invention provides a magnetic recording medium wherein the polymeric binder with pendant hydroxyl groups and purified polyisocyanate crosslinking agent are present in the backcoat.

In another magnetic recording medium embodiment, the invention provides a magnetic recording medium wherein the backcoat containing the purified polyisocyanate crosslinking agent contains less than about 1% free methylene bis(4-phenylisocyanate).

In yet another magnetic recording medium embodiment, the invention provides a magnetic recording medium wherein the front coat comprises a magnetic recording layer and a support or sublayer, and the polymeric binder with pendant hydroxyl groups and a purified polyisocyanate crosslinking agent is present in the sublayer and the sublayer contains less than about 2% free methylene bis(4-phenylisocyanate).

In yet another magnetic recording medium embodiment, a sublayer containing the purified polyisocyanate crosslinking agent contains less then 1% free methylene bis(4-phenylisocyanate).

In another embodiment, the invention provides a magnetic recording medium wherein the front coat comprises a magnetic recording layer and a support or sublayer, and the polymeric binder with pendant hydroxyl groups and the purified polyisocyanate crosslinking agent is present in both the sublayer and the magnetic recording layer, and each of the sublayer and the magnetic recording layer contains less than about 2% free methylene bis(4-phenylisocyanate).

In another magnetic recording medium embodiment, the magnetic recording medium is a magnetic recording tape.

The invention further provides a method for making a purified polyisocyanate crosslinking agent.

These terms when used herein have the following meanings.

1. The term “coating composition” means a composition suitable for coating onto a substrate.

2. The terms “layer” and “coating” are used interchangeably to refer to a coated composition.

3. The term “coercivity” means the intensity of the magnetic field needed to reduce the magnetization of a ferromagnetic material to zero after it has reached saturation, taken at a saturation field strength of 10,000 Oersteds.

4. The term “Oersted,” abbreviated as Oe, refers to a unit of magnetic field in a dielectric material equal to 1/μ Gauss, where μ is the magnetic permeability.

5. The terms “layer” or “coating” are used interchangeably to refer to a coated composition, which may be the result of one or more evaporative processes and one or more passages through the coating apparatus.

6. The term “MDI” is an abbreviation for methylene bis(4-phenylisocyanate).

7. The term “free MDI” or “free diisocyanate compound” means that the MDI or the diisocyanate compound is not part of a larger oligomer or polymer chain.

8. The term “aromatic unhindered polyisocyanate compound” means a compound which contains no groups in the ortho position relative to the isocyanate group on the aromatic ring.

9. The term “time to gelation” means the time of duration at which a component mixture of polyisocyanate crosslinker and polymeric binder containing pendant hydroxy groups in a solvent solution no longer flows under the influence of gravity from the initial time when the components were mixed.

10. The term “NCO equivalents” means isocyanate equivalent weights. The equivalent weight of a group tells you how much weight (grams) of a product you need for one equivalent of reactive group.

11. The term “diisocyanate compound” means the diisocyanate material used to react with polyols to prepare the adducts used as polyisocyanate crosslinking agents.

### DETAILED DESCRIPTION OF THE PREFERRED EMBODIMENTS

The invention provides a magnetic recording medium including a non-magnetic substrate having a front coat coated onto the front side of the substrate and a backcoat on the backside of the substrate wherein at least one of the coatings contains a polymeric binder with pendant hydroxyl groups and a purified polyisocyanate crosslinking agent and less than 2% free diisocyanate compound used to make the polyisocyanate crosslinking agent. The magnetic layer contains at least one metallic particulate pigment and a binder system therefor. The magnetic recording medium may be a magnetic recording tape, and may contain only a single layer in the front coat, i.e., a magnetic recording layer, or the front coat may contain multiple layers such as a magnetic recording layer and one or more support layers.

Purified Polyisocyanate Crosslinking Agent

The purified polyisocyanate crosslinking agent used in coatings of the magnetic recording medium of the invention is an admixture of multiple polyisocyanate compounds and adducts having an average NCO equivalent weight of less than about 600, and preferably an average NCO equivalent weight of from about 300 to about 600.

In one embodiment of the present invention, the crosslinking agent comprises a diisocyanate compound adduct of the formula 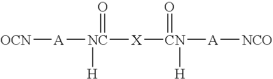
wherein:

each A moiety is independently a divalent, organic linking group; and

X is a divalent organic linking group.

In another embodiment of the invention, the crosslinking agent comprises a duisocyanate compound adduct of the formula 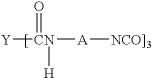
wherein:

each A moiety is as defined above; and

Y is a trivalent organic linking group.

In the practice of the present invention, examples of moieties suitable for use as the A moiety include 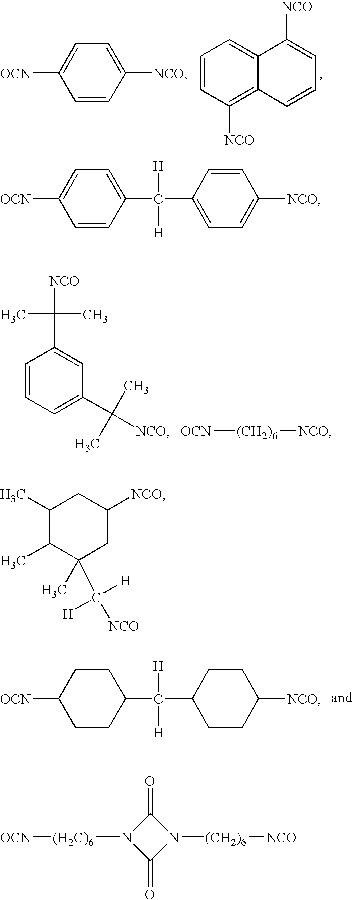
Preferably, the moiety X has the formula
—OR¹O—,
wherein R¹ is a divalent, organic linking group. Examples of moieties suitable for use as R¹ include straight, branched or cyclic alkylene, arylene, aralkylene, polyalkylene oxide, polyalkylene sulfide and polyester moieties. Mixtures of such moieties may also be used. Preferably, R¹ is selected from 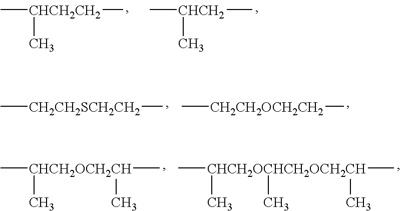
and mixtures thereof.

Preferably, the moiety Y has the formula 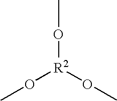
wherein R² is a trivalent, organic linking group. More preferably, R² is selected from

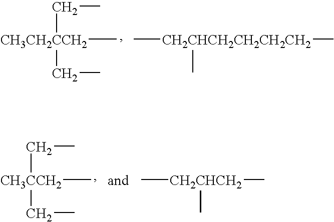

One particularly preferred class of crosslinking agents of the present invention (hereinafter the “preferred crosslinking agent”) comprises a diisocyanate compound of the formula
OCN-A-NCO,
a first diisocyanate compound adduct of the formula 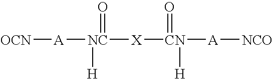
and a second diisocyanate compound adduct of the formula 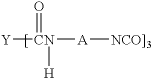
wherein A, X, and Y are as defined above. The preferred crosslinking agent desirably contains less than about 5 weight percent, preferably less than about 2 weight percent, and more preferably less than about 1 weight percent, of the diisocyanate compound. If too much of the diisocyanate compound is present, then the resultant crosslinking agent may not be film-forming. Since moisture is an important reactant in the curing reactions of magnetic and backside coatings, we believe that the ability of the polyisocyanate crosslinking agent to form films improves the mechanical properties, e.g., resilience, durability, and the like, of such coatings. For the preferred crosslinking agent, the weight ratio of the first diisocyanate adduct to the second diisocyanate adduct is in the range from about 1:20 to 20:1, preferably 1:5 to 5:1.

The preferred crosslinking agent can be prepared in a variety of ways. According to one strategy, the preferred crosslinking agent may be prepared according to a two-step reaction scheme. In the first step, a diisocyanate compound, or combination of such diisocyanate compounds, is reacted with one or more diols such that the molar ratio of NCO groups from the diisocyanate to OH groups from the diol(s) is greater than 3:1 and preferably is in the range from about 3:1 to about 4:1. The reaction product of this first step is an admixture containing unreacted diisocyanate compound and an adduct, which is the diol end-capped with the diisocyanate compound. This first reaction step can be represented by the following exemplary reaction in which 1,3 butane diol is end-capped with paraphenylene diisocyanate (“PPDI”): 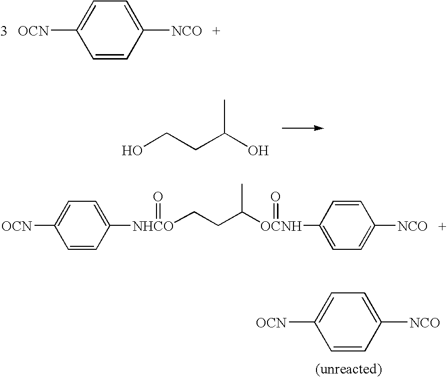
The above reaction is an ideal reaction with no side reactions shown. In practice, though, some side reactions may occur, e.g., coupling reactions instead of capping reactions. As a substitute for carrying out this first reaction step, admixtures containing diol/diisocyanate compound adducts and unreacted diisocyanate compound may be purchased commercially from a manufacturer who, in effect, has already carried out the first reaction step. One specific example of such a material is a prepolymer commercially available under the tradename Isonate™ 2181 from Dow Chemical Co. The Isonate™ 2181 prepolymer is an admixture of about 50 weight percent MDI, about 25% of an adduct of dipropylene glycol end-capped with MDI, and about 25% of an adduct of tripropylene glycol end-capped with MDI. The Isonate 2181 prepolymer is not film-forming.

In a second reaction step, the product prepared or purchased in the first step is reacted with one or more triols in an amount such that the molar ratio of NCO groups from the unreacted diisocyanate compound to OH groups of the triol is preferably about 2:1. The objective of this second step is to end-cap the triol with the diisocyanate compound while minimizing the amount of unreacted diisocyanate compound remaining after this second step. The second reaction step may be represented by the following exemplary reaction in which trimethylolpropane is reacted with the reaction product from the first reaction step, and the trimethylol propane is thereby end-capped with the unreacted PPDI: 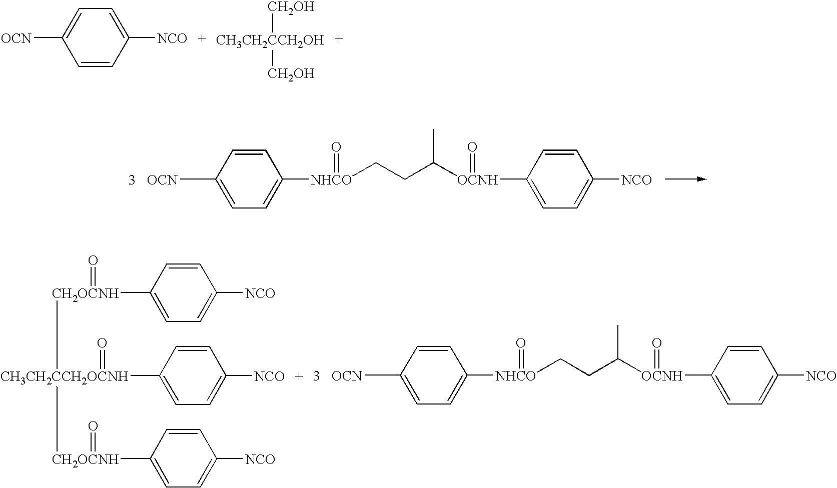
The above reaction is an ideal reaction with no side reactions shown. In practice, though, some side reactions may occur, e.g., coupling reactions instead of capping reactions.

According to another strategy, the preferred crosslinking agent may be prepared according to a different two-step reaction scheme in which the diisocyanate compound, or combination of such diisocyanate compounds, is first reacted with a triol and then a diol. According to the first step of this scheme, the diisocyanate compound is reacted with one or more triols in an amount such that the molar ratio of the NCO groups from the diisocyanate to the OH groups of the triol is preferably about 5:1. The reaction product of this first step is an admixture comprising unreacted diisocyanate compound and an adduct which is the triol end-capped with the diisocyanate compound. In a second step this admixture is reacted with one or more diols in an amount such that the molar ratio of NCO groups from the unreacted diisocyanate compound to the OH groups from the diol is preferably about 2:1.

The preferred crosslinking agent may also be prepared according to a one-step reaction scheme in which the diisocyanate compound, or combination of such diisocyanate compounds, is reacted with a blend of one or more diols and one or more triols. According to this scheme, the molar ratio of NCO groups from the diisocyanate compound to the total moles of OH groups from both the triol and diol preferably is about 2:1.

Examples of diisocyanate compounds suitable for preparing the preferred crosslinking agent have the following structures. 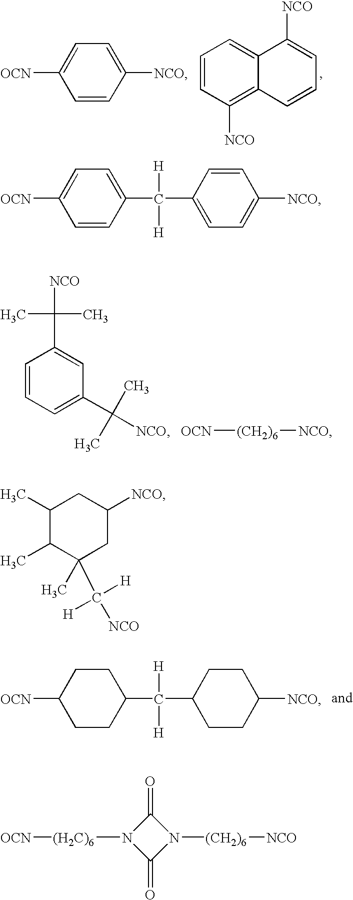
These diisocyanate compounds are available commercially from Bayer Corporation or Nippon Polyurethane Industry Co.

Preferred diisocyanate compounds are aromatic, unhindered diisocyanate compounds. Examples of aromatic, unhindered diisocyanate compounds suitable for preparing the preferred crosslinking agent include methylene bis(4-phenylisocyanate) (“MDI”), paraphenylene diisocyanate (“PPDI”), and 1,5-naphthalenediisocyanate (“NDI”). The use of MDI is most preferred. These isocyanates have the following structures:

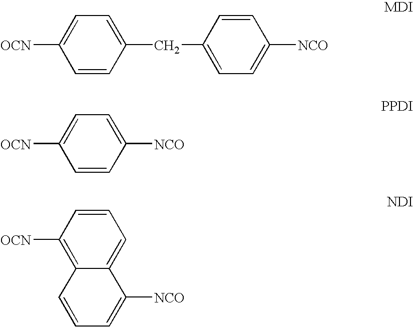

A variety of diols and triols may be used to prepare the preferred crosslinking agent. Examples of diols suitable for use in the practice of the present invention include 1,3-butane diol, diethyleneglycol, 1,2-propyleneglycol, thiol diglycol, diethylene glycol, and mixtures thereof. Examples of triols suitable for use in the practice of the present invention include glycerol, trimethylolpropane, trimethanol ethane, 1,2,6-hexane triol, and mixtures thereof. The weight ratio of the triol to diol used to prepare the preferred crosslinking agent is desirably in the range from about 1:20 to 20:1, preferably 1:5 to 5:1, and more preferably is about 1:1.

A particularly preferred embodiment of the preferred crosslinking agent is an admixture comprising the following components: 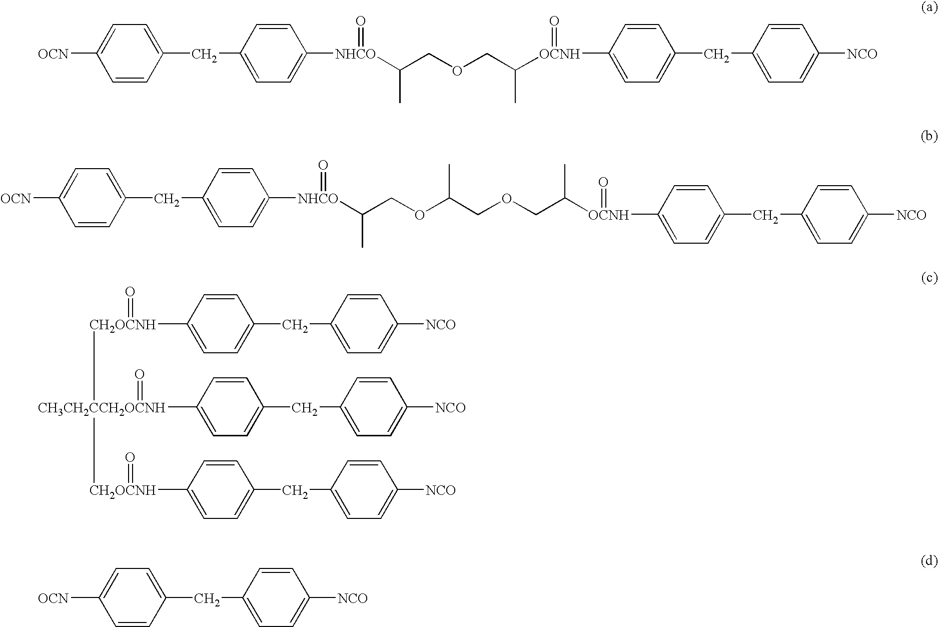
Preferably, the admixture contains about 25 weight percent of component (a), about 25 weight percent of component (b), about 40 weight percent of component (c), and about 10 weight percent of component (d).

Excess MDI has been used in the formation of the polyisocyanate crosslinking agent in order to minimize chain extension of the trimethylolpropane used in the formation of the crosslinking agent. The preferred polyisocyanate crosslinking agents are film-forming, which many other polyisocyanate crosslinking agents are not, which is an advantage. However, since the preferred embodiment of the polyisocyanate crosslinking agent contains excess-free MDI, which is a relatively small molecule, the excess free MDI can migrate out of the coating and cause contamination of post magnetic recording medium formation equipment, such as calendaring rolls.

The free MDI can also react with water to form ureas and polyureas as shown below:

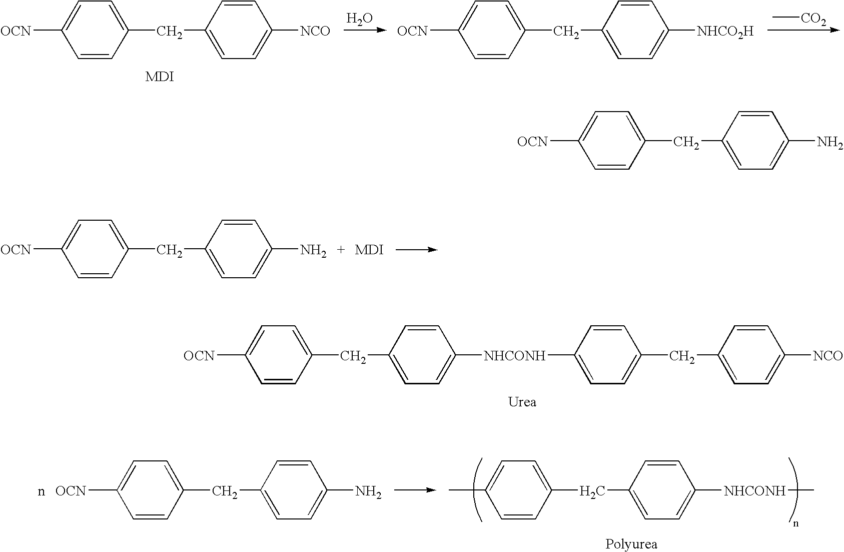

These ureas and polyureas are insoluble, non-film forming materials, which can contribute to poor coating pot life, poor filterability, contamination of the coatings, and debris due to phase separation from the coating formulations.

Therefore, the polyisocyanate crosslinking agent is purified after formation. It has been discovered that the polyisocyanate crosslinking agent can be purified by washing the polyisocyanate crosslinking agent solution with a solvent in which the diisocyanate compound adducts, such as TMP, DPG, and TPG, are insoluble but in which the diisocyanate compound, such as MDI, remains soluble. For example, saturated hydrocarbon solvents may be added to remove free MDI, accompanied by selective precipitation of the desired polyisocyanates, the TMP, DPG and TPG adducts. The undesirable MDI is left in solution to be decanted and discarded. The unpurified polyisocyanate crosslinking agent contains about 10% free MDI, whereas the purified agent contains less than about 2% free MDI. In one embodiment, the purified polyisocyanate crosslinking agent contains less than 1% free MDI. Useful purifying solvents include branched and linear saturated hydrocarbons of five to 12 carbons, mixtures of saturated hydrocarbons and methyl ethyl ketone, mixtures of tetrahydrofuran and saturated hydrocarbons, and acetonitrile. More preferred are saturated hydrocarbon solvents of 5 to 8 carbons. Most preferred are saturated hydrocarbon solvents of 6 carbons, such as hexanes which is a mixture of C6 isomers. Diisocyanate compounds, such as MDI, are soluble in these purifying solvents at the 10 wt % level so when the solutions are precipitated with hexanes or the mixtures, the MDI will remain in the supernatant. The purification process typically consists of multiple washings with the solvents, and the precipitate containing the desired mixture is then redissolved with tetrahydrofuran, methyl ethyl ketone, cyclohexanone or other desirable solvent.

Surprisingly, the purified polyisocyanate crosslinking agents not only yield crosslinking agents with less free diisocyanate compound, such as MDI, but the purified agents also crosslink and gel polyurethane polymers faster than an identical but unpurified crosslinking agent or other commercially available crosslinking agents, as can be demonstrated in “time to gelation” studies of the combination of a polyisocyanate crosslinking agent with polymer binders containing pendant hydroxyl groups in a solvent solution. See Example 3, infra. The purified polyurethane crosslinking agent also gives faster curing in magnetic tape media as is demonstrated in cure studies of magnetic recording films containing a polyisocyanate crosslinker and polymeric binder containing pendant hydroxyl groups using tetrahydrofuran extraction and gel permeation chromatography of fresh and aged films. See Examples 4-6, infra.

The purified polyisocyanate crosslinking agent is preferably incorporated into magnetic coatings, sublayer coatings or backside coatings in an amount such that the equivalent ratio of NCO groups from the crosslinking agent to the hydroxyl groups, or polymers, is greater than 0. Preferably, the equivalent ratio of the NCO groups from the crosslinking agent to the hydroxyl groups from the hydroxyl functional polymer, i.e., a polyurethane polymer or precursor, is in the range from 0.3 to 3.0, more preferably 0.8 to 1.8.

Magnetic Recording Medium

The magnetic recording medium of the invention includes at least one magnetic recording layer. The magnetic recording layer or layers are thin, being preferably from about 0.025 micron (μ), or one microinch, to about 0.25μ, or about 10 microinches in thickness, preferably up to about 0.20μ. Magnetic recording layers of the invention include at least one type of magnetic particulate material. Useful magnetic pigments have compositions including, but not limited to, metallic iron and/or alloys of iron with cobalt and/or nickel, and magnetic or non-magnetic oxides of iron, other elements, or mixtures thereof. Alternatively, the magnetic particles can be composed of hexagonal ferrites such as barium ferrites. In order to improve the required characteristics, the preferred magnetic powder may contain various additives, such as semi-metal or non-metal elements and their salts or oxides such as Al, Nd, Si, Co, Y, Ca, Mg, Mn, Na, etc. The selected magnetic powder may be treated with various auxiliary agents before it is dispersed in the binder system, resulting in the primary magnetic metal particle pigment. Preferred pigments have an average particle length of about 150 nanometers (nm) or less. Such pigments are available from companies such as Toda Kogyo, Kanto Denka Kogyo, and Dowa Mining Company. As noted above, pigments useful in magnetic recording media of the invention have a minimum coercivity of at least about 2000 Oe.

The magnetic layer may also include soft spherical particles. Most commonly these particles are comprised of carbon black. A small amount, preferably less than about 3%, of at least one relatively large particle carbon material may also be included, preferably a material that includes spherical carbon particles. The large particle carbon materials have a particle size on the order of from about 50 to about 500 nm, more preferably from about 70 to about 300 nm. Spherical large carbon particle materials are known and commercially available, and in commercial form can include various additives such as sulfur to improve performance. The remainder of the carbon particles present in the layer are small carbon particles, i.e., the particles have a particle size on the order of less than 100 nm, preferably less than about 50 nm.

The polymeric binder system or resin associated with the magnetic layer incorporates at least one polymeric binder with pendant hydroxyl groups, in conjunction with other resin components such as binders and surfactants, a surfactant (or wetting agent), a head cleaning agent and one or more hardeners. In one embodiment, the binder system of the sublayer includes a combination of a polyurethane resin and a vinyl chloride resin, a vinyl chloride-vinyl acetate copolymer, vinyl chloride-vinyl acetate-vinyl alcohol copolymer, vinyl chloride-vinyl acetate-maleic anhydride, or the like.

In an alternate embodiment, the polyurethane resin is present with a vinyl resin that is a non-halogenated vinyl copolymer. Useful vinyl copolymers include copolymers of monomers comprising (meth)acrylonitrile; a nonhalogenated, hydroxyl functional vinyl monomer; a non-halogenated vinyl monomer bearing a dispersing group, and one or more nonhalogenated nondispersing vinyl monomers. A preferred nonhalogenated vinyl copolymer is a copolymer of monomers comprising 5 to 40 parts of (meth)acrylonitrile, 30 to 80 parts of one or more nonhalogenated, nondispersing, vinyl monomers, 5 to 30 parts by weight of a nonhalogenated hydroxyl functional, vinyl monomer, and 0.25 to 10 parts of a nonhalogenated, vinyl monomer bearing a dispersing group.

Examples of useful polyurethanes include polyester-polyurethane, polyether-polyurethane, polycarbonate-polyurethane, polyester-polycarbonate-polyurethane, and polycaprolactone-polyurethane. Resins such as bisphenol-A epoxide, styrene-acrylonitrile, polyvinylacetal, and nitrocellulose may also be acceptable.

In a preferred embodiment, a primary polymeric polyurethane binder with pendant hydroxyl groups is incorporated into the magnetic layer in amounts of from about 4 to about 10 parts by weight, and preferably from about 6 to about 8 parts by weight, based on 100 parts by weight of the primary sublayer pigment. In a preferred embodiment, the vinyl binder or vinyl chloride binder is incorporated into the magnetic layer in amounts of from about 7 to about 15 parts by weight, and preferably from about 10 to about 12 parts by weight, based on 100 parts by weight of the primary sublayer pigment.

The binder system further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable.

The binder system may also contain a conventional surface treatment agent. Known surface treatment agents, such as phenylphosphonic acid (PPA), 4-nitrobenzoic acid, and various other adducts of sulfuric, sulfonic, phosphoric, phosphonic, and carboxylic acids are acceptable.

The binder system may also contain a hardening agent such as isocyanate or polyisocyanate crosslinker. In a preferred embodiment, the hardener component is incorporated into the sublayer in amounts of from about 2 to about 5 parts by weight, and preferably from about 3 to about 4 parts by weight, based on 100 parts by weight of the primary sublayer pigment.

The magnetic layer may further contain one or more lubricants such as a fatty acid and/or a fatty acid ester. The incorporated lubricant(s) exist throughout the front coating and, importantly, at the surface of the upper layer. The lubricant(s) reduces friction to maintain smooth contact with low drag, and protects the media surface from wear. Thus, the lubricant(s) provided in the upper magnetic layer, and any sublayer present, are preferably selected and formulated in combination.

Optional Sublayer

The sublayer or lower layer of a multi-layer magnetic tape is essentially non-magnetic and typically includes a non-magnetic or soft magnetic powder having a coercivity of less than 300 Oe and a polymeric binder system containing pendant hydroxyl groups. By forming the sublayer to be essentially non-magnetic, the electromagnetic characteristics of the upper magnetic layer are not adversely affected. However, to the extent that it does not create any adverse affect, the sublayer may contain a small amount of a magnetic powder.

The pigment or powder incorporated in the sublayer includes at least a primary pigment material and conductive carbon black. The primary pigment material consists of a particulate material, or “particle” selected from non-magnetic particles such as iron oxides, titanium dioxide, titanium monoxide, alumina, tin oxide, titanium carbide, silicon carbide, silicon dioxide, silicon nitride, boron nitride, etc., and soft magnetic particles having a coercivity of less than 300 Oe. Optionally these primary pigment materials can be provided in a form coated with carbon, tin, or other electroconductive material and employed as sublayer pigments. In a preferred embodiment, the primary sublayer pigment material is a carbon-coated hematite material (α-iron oxide), which can be acidic or basic in nature. Preferred alpha-iron oxides are substantially uniform in particle size, or a metal-use starting material that is dehydrated by heating, and annealed to reduce the number of pores. After annealing, the pigment is ready for surface treatment, which is typically performed prior to mixing with other layer materials such as carbon black and the like. Alpha-iron oxides are well known and are commercially available from Dowa Mining Company, Toda Kogyo, KDK, Sakai Chemical Industry Co, and others. The primary pigment preferably has an average particle size of less than about 0.25 μm, more preferably less than about 0.15 μm.

Conductive carbon black material provides a certain level of conductivity so as to prohibit the front coating from charging with static electricity and further improves smoothness of the surface of the upper magnetic layer formed thereon. The conductive carbon black material is preferably of a conventional type and is widely commercially available. In one preferred embodiment, the conductive carbon black material has an average particle size of less than about 20 nm, more preferably about 15 nm. In the case where the primary pigment material is provided in a form coated with carbon, tin or other electroconductive material, the conductive carbon black is added in amounts of from about 1 to about 5 parts by weight, more preferably from about 1.5 to about 3.5 parts by weight, based on 100 parts by weight of the primary sublayer pigment material. In the case where the primary pigment material is provided without a coating of electroconductive material, the conductive carbon black is added in amounts of from about 5 to about 18 parts by weight, more preferably from about 8 to about 12 parts by weight, based on 100 parts by weight of the primary sublayer pigment material. The total amount of conductive carbon black and electroconductive coating material in the sublayer is preferably sufficient to provide a resistivity at or below about 1×10⁸ ohm/cm².

The sublayer can also include additional pigment components such as an abrasive or head cleaning agent (HCA). One preferred HCA component is aluminum oxide. Other abrasive grains such as silica, ZrO₂, Cr₂O₃, etc., can be employed.

The polymeric binder system or resin associated with the sublayer preferably incorporates at least one polymeric binder containing pendant hydroxyl groups, such as a thermoplastic resin, in conjunction with other resin components such as binders and surfactants used to disperse the HCA, a surfactant (or wetting agent), and one or more hardeners. In one embodiment, the binder system of the sublayer includes a combination of a primary polyurethane resin and a vinyl chloride resin, a vinyl chloride-vinyl acetate copolymer, vinyl chloride-vinyl acetate-vinyl alcohol copolymer, vinyl chloride-vinyl acetate-maleic anhydride, or the like. In an alternate embodiment, the vinyl resin is a non-halogenated vinyl copolymer. Useful vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers. A preferred nonhalogenated vinyl copolymer is a copolymer of monomers comprising 5 to 40 parts of (meth)acrylonitrile, 30 to 80 parts of one or more nonhalogenated, nondispersing, vinyl monomers, 5 to 30 parts by weight of a nonhalogenated hydroxyl functional, vinyl monomer, and 0.25 to 10 parts of a nonhalogenated, vinyl monomer bearing a dispersing group. Useful polyurethanes are described in the description of the magnetic layer.

In one embodiment, a primary polymeric binder with pendant hydroxyl groups is incorporated into the sublayer in amounts of from about 4 to about 10 parts by weight, and preferably from about 6 to about 8 parts by weight, based on 100 parts by weight of the primary sublayer pigment. In a preferred embodiment, the vinyl binder or vinyl chloride binder is incorporated into the sublayer in amounts of from about 7 to about 15 parts by weight, and preferably from about 10 to about 12 parts by weight, based on 100 parts by weight of the primary sublayer pigment.

The binder system for the sublayer may further include an HCA binder, a hardener, one or more lubricants, surface treatment agents and other adjuvants.

The materials for the sublayer are mixed with the surface treated primary pigment and the sublayer is coated to the substrate. Useful solvents associated with the sublayer coating material preferably include cyclohexanone (CHO), with a preferred concentration of from about 5% to about 50%, methyl ethyl ketone (MEK), preferably having a concentration of from about 30% to about 90%, and toluene (Tol) of concentrations from about 0% to about 40%. Alternatively, other ratios can be employed, or even other solvents or solvent combinations including, for example, xylene, tetrahydrofuran, and methyl amyl ketone, are acceptable.

Backcoat

The backcoat primarily consists of a soft (i.e., Moh's hardness <5) non-magnetic particle material such as carbon black. In one embodiment, the backcoat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 25 nm, whereas the secondary, large carbon component preferably has an average particle size on the order of from about 50 to about 300 nm. As is known in the art, backcoat pigments dispersed as inks with appropriate binders, surfactant, ancillary particles, and solvents are typically purchased from a designated supplier. In a preferred embodiment, the backcoat binder includes at least one of: a polyurethane polymer, a phenoxy resin, or nitrocellulose added in an amount appropriate to modify coating tiffness as desired.

In one embodiment, the backcoat is designed to have surplus porosity. This porosity allows high compressibility when the backcoat is calendered during processing of the magnetic recording tape, but also provides a porosity reserve that remains after the calendering processes are completed, and provides extended stress relief to the entire tape pack by continued compression of the backcoat for the full life of the tape. Such a back coat contains at least one non-magnetic particle material such as carbon black, iron oxides, titanium dioxide, alumina, tin oxide, titanium carbide, silicon carbide, silicon dioxide, silicon nitride, boron nitride, and the like. This backcoat formulation preferably contains from about 2% to about 6% by weight percent carbon. The backcoat preferably includes a mixture of pigments including carbon black, and from about 47% to about 63% by weight of alpha iron oxide, and from about 0.5% to about 6% of alumina, along with from about 13% to about 25% of titanium dioxide. The backcoat also contains a polymeric binder system containing pendant hydroxyl groups. When the backcoat contains the purified polyisocyanate crosslinking agent of the invention, the backcoat binder system includes at least one polyurethane resin and one other resin, typically a hard resin. The polyurethane resin generally comprises from about 4% to about 12% by weight of the backcoat formulation, and the hard binder resin comprises from about 3% to about 14% by weight of the formulation. The percentages are weight percents of the solids in the formulation. The pigment is present in the backside coating in amounts of from about 49% to about 55% of the coating composition.

### EXAMPLES

### Example 1

### Purification of Polyisocyanate Crosslinker Based on MDI

10 g of NR-320 (containing 4 g THF and 6 g solids crosslinker) polyisocyanate crosslinker based on MDI (U.S. Pat. No. 5,686,013, Example 1) were weighed into each of 3 vials. NR-320 solids consists of about 25 wt % DPG adduct, about 25 wt % TPG adduct, about 40 Wt % TMP adduct, and about 10 wt % free MDI. The first vial was washed once with 16 g 98.5% hexanes (HPLC grade, ACROS) to produce a precipitate. The supernatant was dried to give 0.44 g. By mass balance, 5.56 g (92.7%) of NR-320 was recovered (see Table 2). The precipitate was redissolved in 13 g MEK after the final washing to give a workable viscosity. Water was added to this solution to give an estimated NCO:H₂O ratio of 1. After 2 hours, an opaque gel formed, indicating that not all the MDI had been removed after one washing with 16 g hexanes.

The second vial was washed twice with 16 g hexanes. The precipitate was redissolved in 4 g MEK between washings. The precipitate was redissolved in 13 g MEK after the final washing to give a workable viscosity. Water was added to this solution to give an estimated NCO:H₂O ratio of 1. After 3.5 hours, an opaque gel formed (FIG. 4), indicating that not all the MDI had been removed after two washings with 16 g hexanes.

The third vial was washed three times with 16 g hexanes. The precipitate was redissolved in 4 g MEK between washings. The supernatants were combined and dried to give 1.23 g. By mass balance, 4.77 g (79.6%) of purified NR-320 was recovered. The purified NR-320 was redissolved in 13 g MEK after the final washing to give a workable viscosity. Water was added to this solution to give an estimated NCO:H₂O ratio of 0.75. After 3.25 hours, a clear gel formed, indicating that a majority of the free MDI had been removed after three washings with 16 g hexanes.

### Example 2

### Purification of 1Polyisocyanate Crosslinker Based on MDI

1175 g NR-320 (705 g dry NR-320, 470 g THF) was weighed into a 4 L bottle. To this was added 2800 ml 98.5% hexanes (HPLC grade, ACROS). The bottle was shaken and allowed to settle for 30 min. The supernatant was decanted and 270 ml MEK added to redissolve the solid. Two more precipitation steps were carried out. 1222.66 g of 46.5 wt % purified NR-320 in MEK resulted after the 3rd precipitation step. This represents an 80.6% yield of purified NR-320. The isocyanate equivalent weight of unpurified NR-320 was 342. The isocyanate equivalent weight of purified NR-320 was 512.

### Example 3

### Gelation of Polymer Solutions Using Purified Polyisocyanate Crosslinker

Unpurified NR-320 and purified NR-320 prepared in Example 2 were added separately to 52:48 nitrocellulose (Mn 16,000; hydroxyl equivalent weight 350)/polyester polyurethane (Mn 20,000; hydroxyl equivalent weight 10,000) solutions in 4:1 MEK/toluene to give a final % solids of 24%. The ratio of NCO:OH was 1:1 in each case. The solution with unpurified NR-320 gelled in 139 hours whereas the solution with purified NR-320 gelled in 81 hours. A similar reduction in gelation time was experienced with other hydroxylated polymers as well. With most of the low molecular weight MDI removed in the purification step, the composition of NR-320 changes and the NCO equivalent weight increases. By way of explanation, the percentage of TMP triisocyanate adduct increases, which should increase the rate of gelation using purified NR-320. Since about 80% of purified NR-320 is recovered, more is removed in the purification process than just MDI. It is likely that more of the lower molecular weight DPG and TPG adducts would be removed than the TMP adduct. This would increase the percentage of TMP triisocyanate adduct even more.

### Example 4

A cure study was performed comparing equal weight percents of a polyisocyanate based on toluene diisocyanate (CB55N, Bayer) and purified NR-320 polyisocyanate based on diphenylmethane 4,4′-diisocyanate (U.S. Pat. No. 5,686,013, Example 1) prepared in Example 2 in a backside coating dispersion.

A backside coating dispersion was prepared using the following formulation:

| Backside dispersion ingredient | Parts by weight |
|---|---|
| Carbon Black | 36.8 |
| (particle size 24 nm) | |
| TiO₂ | 11.3 |
| (particle size 300 nm) | |
| Al₂O₃ | 2.3 |
| (particle size 200 nm) | |
| Block copolymer dispersant | 2.1 |
| Nitrocellulose | 22.5 |
| Polyester polyurethane | 14.9 |
| (Mn 24,800 containing sodium sulfonate) | |
| Polyisocyanate solution (see Table 1) | 10.2 |
| Methylethylketone | 397 |
| Toluene | 142 |
| Cyclohexanone | 28 |

Preparation of the back coat coating material preferably entails mixing the various components, including a solvent, in a planetary mixer or similar device, and then subjecting the dispersion to a sandmilling operation. Subsequently, the material is processed through a filtration operation in which the material is passed through a number of filters.

The substrate is coated with the backcoating on one side of the substrate and the front coat layer(s) on the other side of the substrate. The coatings are dried, using suitable ovens. The coated substrate then proceeds to the calendering station. Calendering provides a desired degree of smoothness to the magnetically coated side of the substrate. The coated, calendered substrate is then slit, tested for defects and wound into final product form.

The cure study involved extraction of a standard area of coating with THF at time zero (fresh coatings), after 24 hours heat soaking at 60° C., and after room temperature aging for 3 weeks. The THF extracts were then analyzed by gel permeation chromatography using an internal toluene standard and THF eluent. The GPC curves were composed of two regions: The polymer region (representing the high MW polymeric binders) and the oligomer region (representing the polyisocyanate and low MW polymeric binders). The area under the two regions of the GPC curves is an indication of the relative amount of polymer and polyisocyanate that is extracted from the coatings. Lower GPC curve areas are indicative of lower extracted amounts and therefore of a greater extent of cure. Cure is defined as a crosslinking of polymers by the polyisocyanate or gelation of the polyisocyanate itself from reaction with water to form polyureas, either of which is insoluble in THF. The cure results are reported in Table 1 as the total % cure based on the area under the GPC curve for both the polymer region and oligomer region.

TABLE 1

| | | | % Cure (Total) | |
|---|---|---|---|---|
| Polyisocyanate | PBW of | PBW of | 60° C. heat | 3 weeks |
| solution | solution | polyisocyanate | soak 24 hours | at RT |
| CB55N | 18.5 | 10.2 | 39.8 | 16.5 |
| (55% in MEK) | | | | |
| Purified NR-320 | 20 | 10.2 | 63.9 | 34 |
| (51% in MEK) | | | | |

The sample with the purified NR-320 showed a much higher degree of curing, both after heat soaking and after three weeks at room temperature.

### Example 5

A cure study was performed comparing equal weight percents of unpurified and purified NR-320 polyisocyanate (U.S. Pat. No. 5,686,013, Example 1) prepared in Example 2 in a backside coating dispersion.

A backside coating dispersion was prepared using the following formulation:

| Backside dispersion ingredient | Parts by weight |
|---|---|
| TiO₂ | 62.5 |
| (particle size 300 nm) | |
| Carbon Black | 50 |
| (particle size 270 nm) | |
| Carbon Black | 200 |
| (particle size 42 nm) | |
| Al₂O₃ | 10.5 |
| (particle size 320 nm) | |
| Nitrocellulose | 102.1 |
| Polyester polyurethane | 153.2 |
| (Mn approximately 30,000) | |
| Lecithin | 9.98 |
| Phosphorylated polyoxyalkyl polyol | 0.14 |
| (described in U.S. Pat. No. 5,028,483, col. 5) | |
| Emcol phosphate dispersant | 0.11 |
| (Witco Corp.) | |
| Cyclohexanone | 406 |
| Tetrahydrofuran | 2459 |
| Methylethylketone | 652 |
| Toluene | 164 |
| Polyisocyanate solution | (see Table 2) |

The Al₂O₃ was predispersed and premilled at approximately 73.3% solids in tetrahydrofuran with 1 part of the phosphorylated polyoxyalkyl polyol and 0.73 parts Emcol phosphate. The carbon blacks, TiO₂, lecithin, nitrocellulose, and polyester polyurethane were mixed with THF, cyclohexanone, MEK, and toluene (70:20:8:2) at about 16% solids in a high-speed mixer and then milled in a horizontal sand mill until smooth. The predispersed Al₂O₃ and additional nitrocellulose and polyester polyurethane (40:60 blend in 4:1 MEK/toluene, 24% solids) were added with high speed mixing to bring the solids to about 18.3%. The resulting mixture was thinned down to about 14% using tetrahydrofuran. Prior to coating, the polyisocyanate crosslinking agent solution was blended into the dispersion and the mixture was filtered.

The backside dispersion was applied to 24-gauge polyethylene naphthenate (PEN) film using a die coating apparatus. The coated film was passed through an oven set at 80° C. to drive off volatile materials.

The cure study involved extraction of a standard area of coating with THF at time zero (fresh coatings) and after room temperature aging for 1, 2 and 3 weeks. The GPC procedure was the same as described in Example 1. The cure results are reported in Table 2 as the total % cure based on the area under the GPC curve for both the polymer region and oligomer region as described in Example 4.

TABLE 2

| Polyisocyanate | PBW of | PBW of | % Cure (Total) | | |
|---|---|---|---|---|---|
| solution | solution | polyisocyanate | 1 week | 2 weeks | 3 weeks |
| Unpurified | 138 | 82.8 | 55.6 | 73.1 | 82.4 |
| NR-320 | | | | | |
| (60% in THF) | | | | | |
| Purified | 162.4 | 82.8 | 69.6 | 75 | 77.5 |
| NR-320 | | | | | |
| (51% in MEK) | | | | | |

The purified polyisocyanate gave significantly higher percentage cure after 1 week than unpurified polyisocyanate when compared at the same weight percent in the dried coating. All of the stock rolls experienced nearly the same percentage of cure after 3 weeks, as one would expect given enough time to age. However, a greater percent cure is desirable during the first week for purposes of handling and control.

### Example 6

A cure study was performed comparing a polyisocyanate based on toluene diisocyanate (CB55N from Bayer) and purified NR-320 polyisocyanate (U.S. Pat. No. 5,686,013, Example 1) prepared in Example 2 in a non-magnetic sublayer coating dispersion in which the number of isocyanate equivalents was the same.

A sublayer coating dispersion was prepared using the following formulation:

| Sublayer dispersion ingredient | Parts by weight |
|---|---|
| Alpha-Iron oxide | 88.18 |
| (particle size 0.11 μm, | |
| surface area 65 m²/gm, pH 9) | |
| Chrome orange dispersant | 1.76 |
| (U.S. Pat. No. 6,805,950B2, Col. 6) | |
| Polyester polyurethane | 12.46 |
| (Mn 11,000, Tg 79° C.) | |
| Polyester polyurethane | 6.23 |
| (Mn 20,000, Tg 40° C.) | |
| Polyester polyurethane | 0.57 |
| (Dispersant for Al₂O₃; | |
| Mn 18-30,000; Tg 73-77° C.) | |
| Carbon Black | 4.41 |
| (particle size 30 nm) | |
| Al₂O₃ | 4.41 |
| (particle size 130 nm) | |
| Stearic Acid | 1.32 |
| Butyl Stearate | 0.88 |
| Methylethylketone | 118.73 |
| Cyclohexanone | 47.49 |
| Toluene | 71.24 |
| Polyisocyanate solution | (see Table 3) |

The Al₂O₃ was predispersed and premilled at 55.2% solids in 4:1 MEK/cyclohexanone solvent blend with the polyester polyurethane resin of Mn 18-30,000. The chrome orange acid, alpha-iron oxide, and MEK were pre-mixed in a double planetary mixer. The polyester polyurethanes, carbon black, and a solvent blend of 50:20:30 MEK/cyclohexanone/toluene were then added to prepare a 66% solids mixture for continued mixing in the double planetary mixer. This dispersion was thinned down with a solvent blend of 50:20:30 MEK/cyclohexanone/toluene and the predispersed Al₂O₃ was added to give a 33.5% solids dispersion. This dispersion was milled until smooth in a horizontal sand mill and filtered. Stearic acid, butyl stearate, and the polyisocyanate crosslinking agent solution were blended into the dispersion prior to coating. The sublayer dispersions were applied to 24-gauge polyethylene naphthenate (PEN) film at 36% solids using a die coating apparatus. The coated film was passed through an oven set at 91° C. to drive off volatile materials.

The cure study involved extraction of these coatings with THF at time zero (fresh coatings), after heat soaking for 24 hours at 60° C., and after room temperature aging for 1 week. The GPC procedure was the same as described in Example 1. The cure results are reported in Table 3 as the total % cure based on the area under the GPC curve for both the polymer region and oligomer region as described in Example 4.

TABLE 3

| | | | | % Cure (Total) | |
|---|---|---|---|---|---|
| | | | | 60° C. | |
| Polyisocyanate | PBW of | NCO | NCO | heat soak | 1 week |
| solution | solution | eq. wt. | equivalents | 24 hours | at RT |
| CB55N | 6.41 | 241 | 0.0146 | 34.7 | 11.3 |
| (55% in MEK) | | | | | |
| Purified | 14.66 | 512 | 0.0146 | 63.9 | 48.6 |
| NR-320 | | | | | |
| (51% in MEK) | | | | | |

The sample with the purified NR-320 showed a much higher degree of curing, even without heat soaking.

What is claimed is:

1. A purified polyisocyanate crosslinking agent comprising at least one diisocyanate compound adduct selected from the group consisting of adducts having a formula 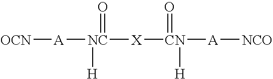
wherein:
each A moiety is independently a divalent, organic linking group; and
X is a divalent organic linking group, and
a diisocyanate compound adduct of the formula 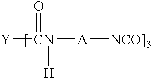
wherein:
each A moiety is as defined above; and
Y is a trivalent organic linking group, said purified polyurethane crosslinking agent containing less than 2% free diisocyanate compound.

2. A purified polyurethane crosslinking agent according to claim 1, wherein said moiety A is selected from the group consisting of 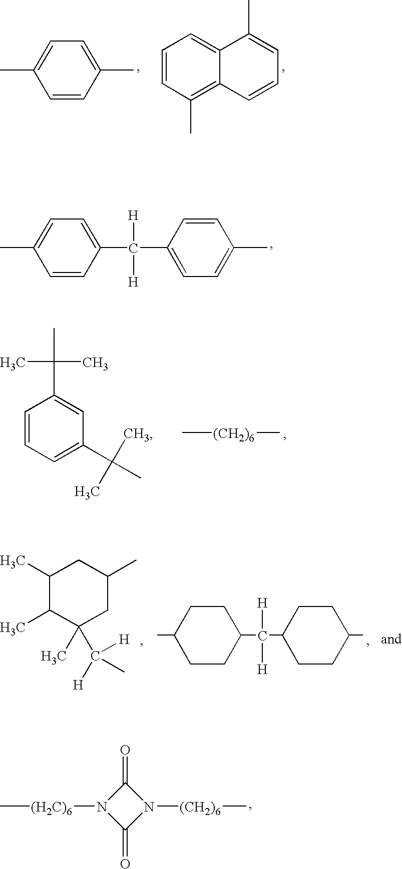
said moiety X has the formula
—OR¹O—,
wherein R¹ is a divalent, organic linking group selected from the group consisting of 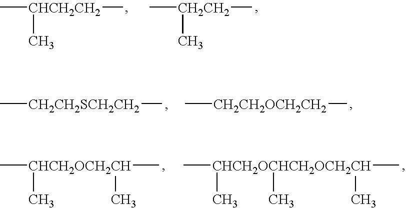
and said moiety Y has the formula 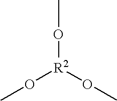
wherein R² is a trivalent, organic linking group selected from the group consisting of

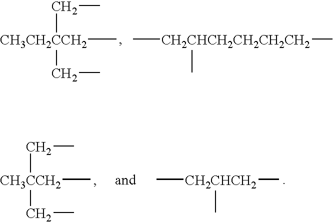

3. A purified polyurethane crosslinking agent according to claim 1, wherein each A moiety is an independently selected divalent, organic linking group having a chemical structure such that each NCO group pendant from each A moiety is aromatic and unhindered, and is selected from the group consisting of

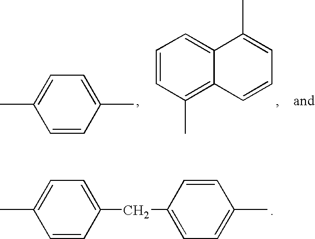

4. A purified polyisocyanate crosslinking agent according to claim 1, comprising at least one diisocyanate compound adduct having the formula DPG, 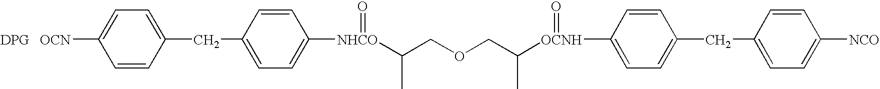
a second diisocyanate compound adduct having the formula TPG, 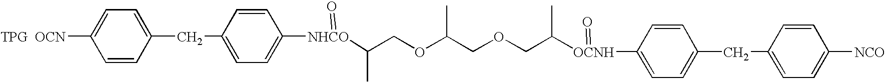
and a third diisocyanate compound adduct having the formula TMP 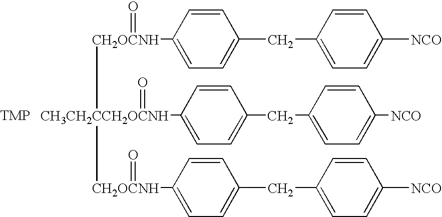
wherein said purified polyurethane crosslinking agent contains less than about 2% free methylene bis(4-phenylisocyanate).

5. A magnetic recording medium comprising a substrate having coated thereon a front coat and a backcoat, said front coat comprising at least a magnetic coating, wherein at least one of said front coat or said backcoat contains at least a polymeric binder with pendant hydroxyl groups and a purified polyisocyanate crosslinking agent therefor, said purified polyisocyanate crosslinking agent comprising at least one diisocyanate compound adduct selected from the group consisting of adducts having a formula 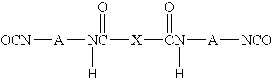
wherein:
each A moiety is independently a divalent, organic linking group; and
X is a divalent organic linking group, and
a diisocyanate compound adduct of the formula 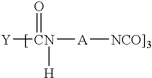
wherein:
each A moiety is as defined above; and
Y is a trivalent organic linking group, and
wherein said coating contains less than 2% free diisocyanate compound.

6. A magnetic recording medium according to claim 5 wherein said moiety A is selected from the group consisting of 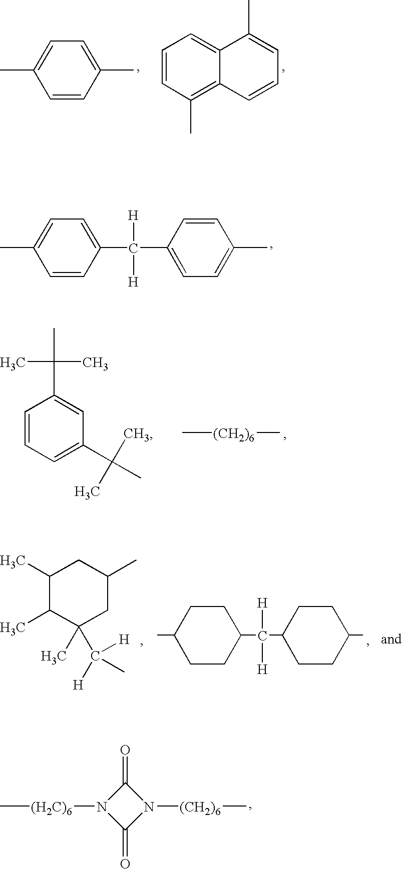
said moiety X has the formula
—OR¹O—,
wherein R¹ is a divalent, organic linking group selected from the group consisting of 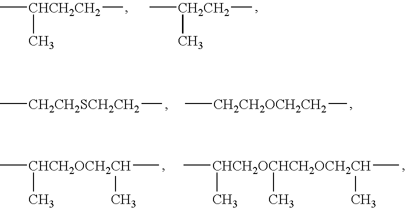
and said moiety Y has the formula 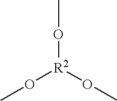
wherein R² is a trivalent, organic linking group selected from the group consisting of

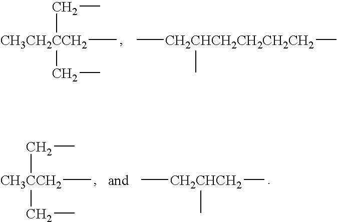

7. A magnetic recording medium according to claim 5, wherein each A moiety is an independently selected divalent, organic linking group having a chemical structure such that each NCO group pendant from each A moiety is aromatic and unhindered, and is selected from the group consisting of

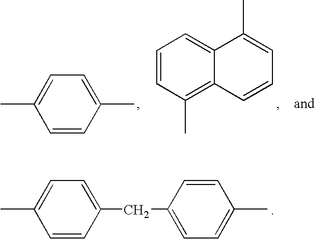

8. A magnetic recording medium comprising a substrate having coated thereon a front coat and a backcoat, said front coat comprising at least a magnetic coating and at least one of said front coat or said backcoat containing at least a polymeric binder with pendant hydroxyl groups and a purified polyisocyanate crosslinking agent therefore comprising at least one diisocyanate compound adduct having the formula DPG, 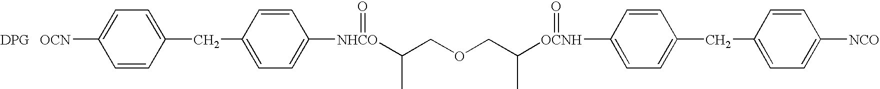
a second diisocyanate compound adduct having the formula TPG, 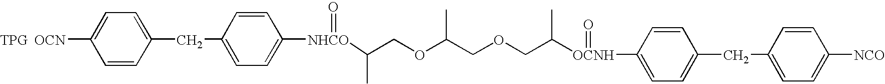
and a third diisocyanate compound adduct having the formula TMP 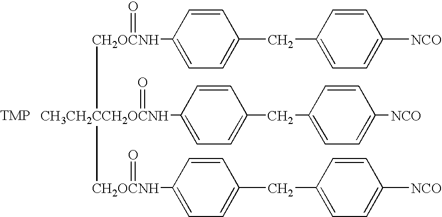
wherein said coating contains less than about 2% free methylene bis(4-phenylisocyanate).

9. A magnetic recording medium according to claim 5, wherein said purified polyisocyanate crosslinking agent is present in said backcoat.

10. A magnetic recording medium according to claim 9, wherein said backcoat comprises from about 0.3 to 3.0 NCO equivalents from the crosslinking agent to hydroxyl groups present in the polymeric binder with pendant hydroxyl groups.

11. A magnetic recording medium according to claim 10, wherein said backcoat comprises up to about more preferably 0.8 to 1.8 NCO equivalents from the crosslinking agent to hydroxyl groups present in polymeric binder with pendant hydroxyl groups.

12. A magnetic recording medium according to claim 5, wherein said backcoat further comprises from about 2% to about 6% by weight percent carbon, from about 49% to about 55% of a mixture of pigments including said carbon black, alpha iron oxide, alumina, and titanium dioxide.

13. A magnetic recording medium according to claim 5, wherein said magnetic recording medium is a magnetic recording tape having a front coat comprising a magnetic layer and a sublayer, and said purified polyisocyanate crosslinking agent is present in at least one of said layers of said front coat.

14. A magnetic recording medium according to claim 13, wherein said purified polyisocyanate crosslinking agent is present in said sublayer.

15. A magnetic recording medium according to claim 14, wherein said sublayer comprises from about 0.3 to 3.0 NCO equivalents from the crosslinking agent to hydroxyl groups present in the polymeric binder with pendant hydroxyl groups.

16. A magnetic recording medium according to claim 15, wherein said purified polyisocyanate crosslinking agent is present in said magnetic recording layer.

17. A magnetic recording medium according to claim 16, wherein said sublayer comprises from about 0.3 to 3.0 NCO equivalents from the crosslinking agent to hydroxyl groups present in the polymeric binder with pendant hydroxyl groups.

18. A magnetic recording medium according to claim 17, wherein the purified polyisocyanate crosslinking agent is present in both the sublayer and the magnetic recording layer, and each of the sublayer and the magnetic recording layer contains less than about 2% free methylene bis(4-phenylisocyanate).

19. A magnetic recording medium according to claim 18, wherein said magnetic layer comprises magnetic metallic pigment particles having a coercivity of at least about 2000 Oersteds (Oe), said pigment particles having an average particle length of no more than about 100 nm.
